(19) United States
(12) Patent Application Publication
(10) Pub. No.: US 2019/0362439 A1
(43) Pub. Date: Nov. 28, 2019

(54) Method of Implementing a Social Network for Scoring Service and Generosity and Providing Character Identification Testing

(71) Applicant: David Roseberry, Ammon, ID (US)

(72) Inventor: David Roseberry, Ammon, ID (US)

(21) Appl. No.: 16/400,718

(22) Filed: May 1, 2019

Related U.S. Application Data
(60) Provisional application No. 62/675,282, filed on May 23, 2018.

(51) Int. Cl. G06Q 50/00; G06Q 30/02

(52) U.S. Cl. CPC G06Q 50/01; G06Q 30/0239

(57) ABSTRACT

A method of implementing a social network for character testing is provided with a user account managed by a remote server. A user submits at least one service activity through a PC device associated with the user account, along with at least one service evidence for the service activity. Subsequently, the remote server executes an authentication process for the service activity with the provided service evidence. This allows the remote server to generate at least one verified service activity which has been authenticated in the authentication process. Finally, the remote server computes a social-service score for the user account from the verified service activity and assigns the social-service score to the user account.

The current application claims a priority to the U.S. Provisional Patent application Ser. No. 62/675,282 filed on May 23, 2018.

### FIELD OF THE INVENTION

The present invention generally relates to a method of implementing a social network for scoring service and generosity and providing character identification testing. More specifically, the present invention is a method for calculating a social-service score that can be used on job applications, resumes, loan applications, school applications, clubs, groups and the like.

### BACKGROUND OF THE INVENTION

A very large working population will be retiring soon, taking years of experience with them, and the upcoming work force has been raised on video games and social media, creating a large experience gap to fill and a work force that is addicted to electronics. Businesses are only as good as their employees. HR departments need a faster way to get more information about someone's experience and character than a 1-page resume. The resume outline is too short and outdated. A 1-page resume of education, work experience, and accomplishments is not enough information to evaluate candidates in this competitive work environment. Technology has changed 100-fold, leaving schools, banks, employers, and candidates without out-of-date ways of representation. Matching up vague job descriptions with a general resume is like walking through a crowded room in hopes of finding a soulmate with just a glance.

Imagine children being taught the value of work again and how to think of others. Imagine a culture changing back to a mindset of serving others and working for a better tomorrow instead of instant self-gratification alarmingly wide-spread, sky-rocking, self-mutilation, depression, and suicide. Therefore, it is an object of the present invention to address these issues by providing users with a website and app based on reporting service, hard work, and learning from society's short comings measured by a score, as well as peer reviewed personality tests represented in a character identification number (CIN).

### BRIEF DESCRIPTION OF THE DRAWINGS

FIG. 1 is a block diagram illustrating the system of the present invention.

FIG. 2 is a flowchart of the overall process for the method of the present invention.

FIG. 3 is a flowchart illustrating the subprocess for authenticating a service activity with a user-inputted evidence.

FIG. 4 is a flowchart illustrating the subprocess for calculating the social-score in accordance with a scoring system.

FIG. 5 is a flowchart illustrating the subprocess for configuring the scoring system with a plurality of preset settings.

FIG. 6 is a flowchart illustrating the subprocess for modifying the scoring system by the administrator account.

FIG. 7 is a flowchart illustrating the subprocess for prompting the verifier account to verify the service evidence.

FIG. 8 is a flowchart illustrating the subprocess for verifying the service evidence through a trustworthy contact.

FIG. 9 is a flowchart illustrating the subprocess for selecting a qualifying opportunity from the plurality of service opportunities.

FIG. 10 is a flowchart illustrating the subprocess for selecting a qualifying discount from the plurality of business discounts.

FIG. 11 is a flowchart illustrating the subprocess for generating an update notification for the social service score and displaying the update notification to each preferred account.

FIG. 12 is a flowchart illustrating the subprocess for relaying the social-service score to a secondary account on an external social network.

### DETAILED DESCRIPTION OF THE INVENTION

All illustrations of the drawings are for the purpose of describing selected versions of the present invention and are not intended to limit the scope of the present invention.

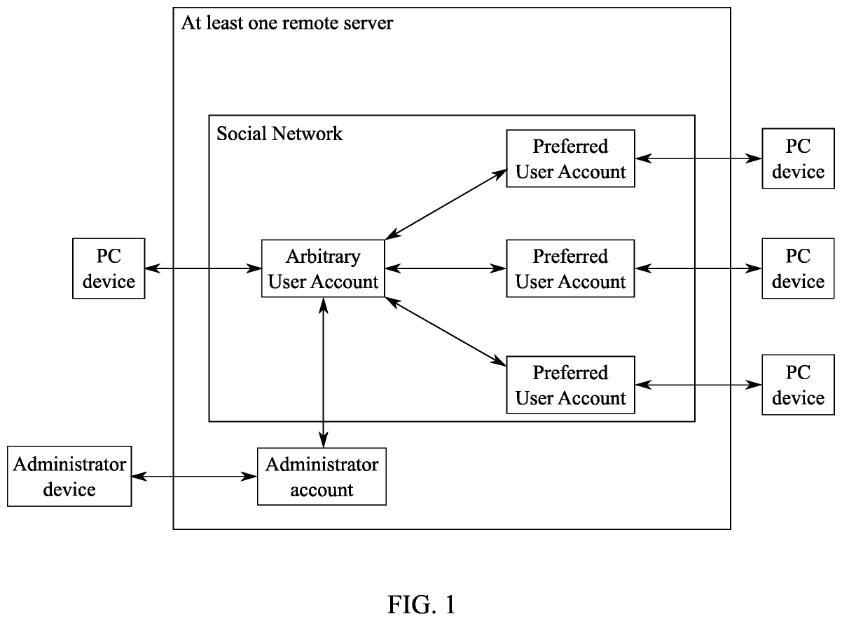

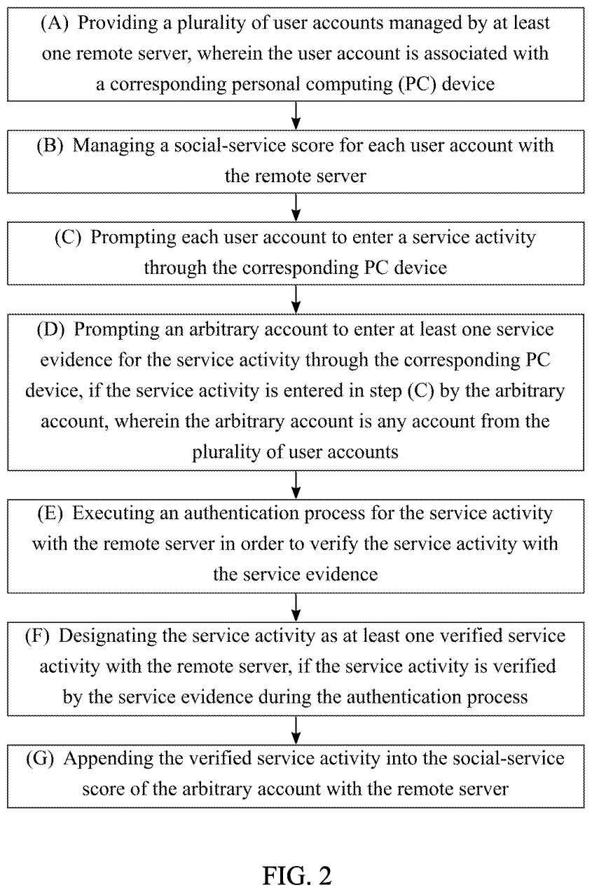

The present invention is a method of implementing a social network for character testing and rewarding social service. More specifically, the present invention is a method for giving credit to users for acts of social service they have performed. The acts of social service are used to derive a single numerical score that can be shared through external social media platforms. The score may be derived via a plurality of methods and formulae depending on the types of service activities that the user has performed. In the preferred embodiment, the present invention is a website and mobile application for assessing a person's social service, hard work, and learning from society's short comings with a single peer-reviewed score that includes, but is not limited to, peer reviewed personality tests. As can be seen in FIG. 1 and FIG. 2, the preferred embodiment of the method of the present invention is provided with a plurality of user accounts managed by at least one remote server, wherein the user account is associated with a corresponding personal computing (PC) device (Step A). Preferably, the PC device acts as a terminal for collecting data and transmitting data to the remote server. The PC device can be, but is not limited to, smartphones, laptops, desktops, personal digital assistants (PDAs), smartwatches, and the like. The at least one remote server may be a monolithic or distributed computing system responsible for storing, processing, and outputting data to the PC device. In one possible embodiment, the data may be collected directly from the corresponding PC device of each user account.

The overall process followed by the method of the present invention allows its users to have their character tested, tracked, and rewarded. The user account is managed by the remote server and is accessed via the corresponding PC device. In the preferred implementation, to sign up for the user account, the user must undergo a verification process which proves the user's real identity with bills featuring the user's name and address, as well as an email address and the last four digits of the user's social security number. Accordingly, the remote server performs the verification process, wherein the user's social security number and the email address are validated. Subsequently, this completes the setup of the user account, whereby the user can submit service activities and receive the associated information. Preferably, the remote server manages a social-service score for each user account (Step B). The social service score quantifies the good acts performed by the user into a numerical value Like a credit score, the social service score can be used to vet a candidate for school applications, loans, job interviews, and dating sites. For example, the social service score may be used by employers to screen prospective employees or by schools in the admissions process.

Subsequently, the corresponding PC device prompts each user account to enter a service activity through (Step C). The service activity can be, but is not limited to, pro-bono volunteering work performed by the user, such as volunteering at hospitals, schools, shelters, food banks, or like non-profit organizations. The service activity can also be military services, blood/organ donations, and the like. The user account allows the user to upload service activities and the associated service evidence to the remote server. In the preferred embodiment, the user account includes a submission form for submitting the service activity. The submission form allows the user to enter information about the service activity such as dates, descriptions, and supporting documentation. Further, the submission form may also include fields for the contact information of references and uploading videos and/or pictures.

Accordingly, the corresponding PC device prompts an arbitrary account to enter at least one service evidence for the service activity, if the service activity is entered in step C by the arbitrary account, wherein the arbitrary account is any account from the plurality of user accounts (Step D). In the preferred embodiment, the service evidence can be, but is not limited to, additional documents, pictures, videos, and relevant references to authenticate the service activity. Subsequently, the remote server executes an authentication process for the service activity in order to verify the service activity with the service evidence (Step E). In one possible embodiment, the remote server may manage an administrator account capable of performing the authentication process. For example, the administrator accounts may allow an administrator to manually inspect the documents, pictures, and videos provided by the user, as well as contact the references to validate the service activity.

Subsequently, the remote server designates the service activity as at least one verified service activity, if the service activity is verified by the service evidence during the authentication process (Step F). In the preferred embodiment, the remote server prompts the administrator account to authenticate the verified service activity. For example, the administrator account may require a user to manually inspect the verified service activity. Subsequently, the remote server appends the verified service activity into the social-service score of the arbitrary account (Step G). More specifically, the verified service activity is used to update the social-service score to give a more accurate reflection of the overall social character of the user.

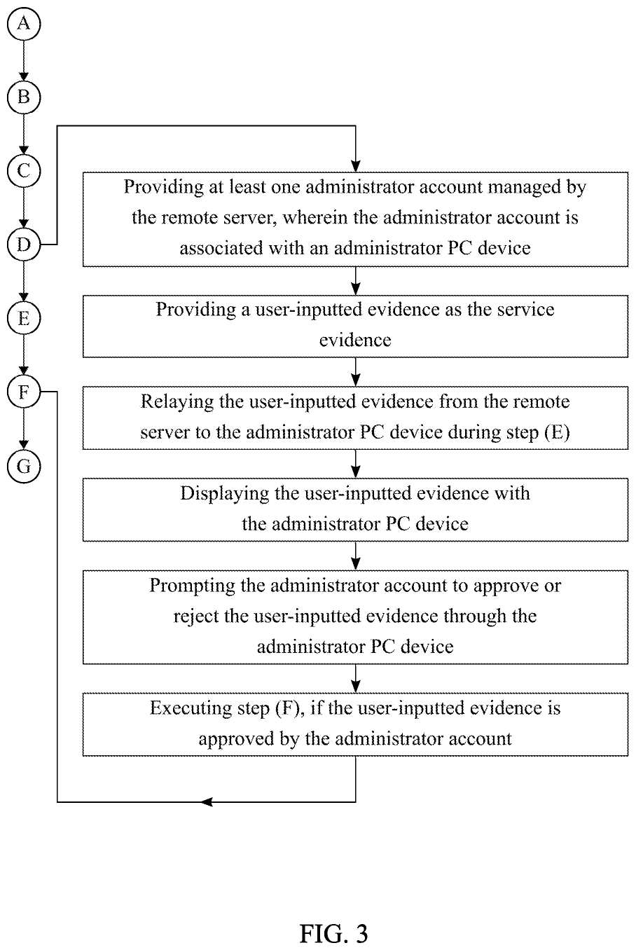

In the preferred embodiment, at least one administrator account managed by the remote server is provided, wherein the administrator account is associated with an administrator PC device. As can be seen in FIG. 3, the administrator account enables the administrator to inspect the service evidence and accordingly authenticate the service activity. The service activity is then designated as the verified service activity by the remote server. In one scenario of the present invention, a user-inputted evidence is provided as the service evidence. The user-inputted evidence can be, but is not limited to, digital documents and/or scanned paperwork attesting to the completion of the service activity. Further, the user-inputted evidence can also be visual evidence such as photos and videos of the user performing the service activity.

Accordingly, the user-inputted evidence is relayed from the remote server to the administrator PC device during step E. This allows the administrator to inspect the user-inputted evidence remotely from anywhere in the world. More specifically, the administrator device connects to the remote server through an internet connection from anywhere in the world, thereby allowing the user-inputted evidence to be relayed to the administrator PC device. Accordingly, the administrator may review the user-inputted evidence and conduct the authentication process. Further, the user-inputted evidence is stored in the remote server for future retrieval by the administrator account.

Subsequently, the administrator PC device displays the user-inputted evidence. Further, the administrator PC device prompts the administrator account to approve or reject the user-inputted evidence. In the preferred embodiment, the administrator PC device may display a visual media of the user-inputted evidence such as a screenshot of supporting documents and/or videos/images of the user performing the service. The administrator may manually examine the user-inputted evidence and accordingly approve or reject the service activity. If the user-inputted evidence is approved by the administrator account, step F is executed. This concludes the authentication process for service activities with user-provided evidence.

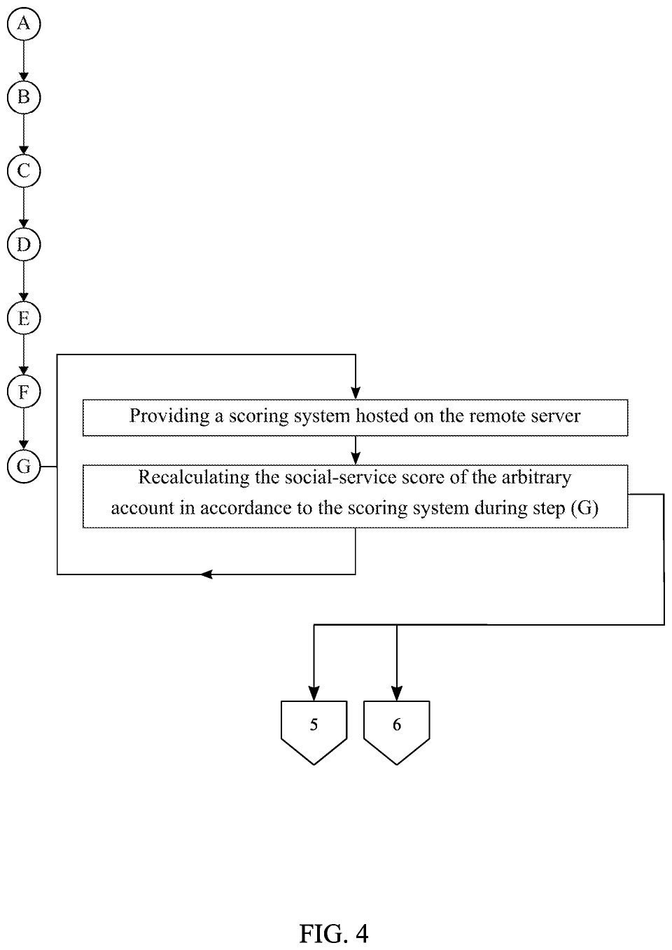

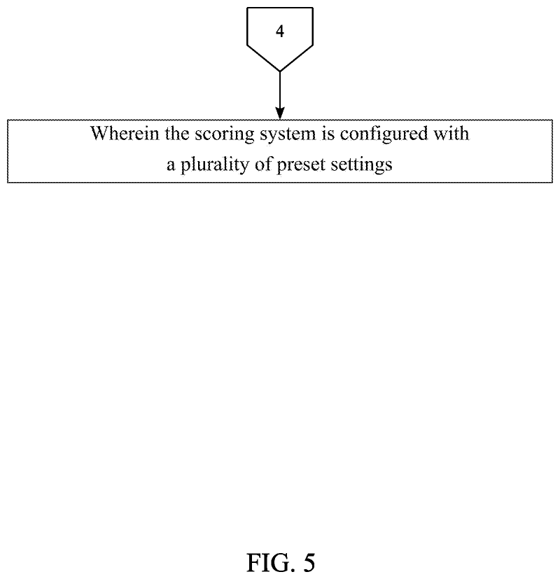

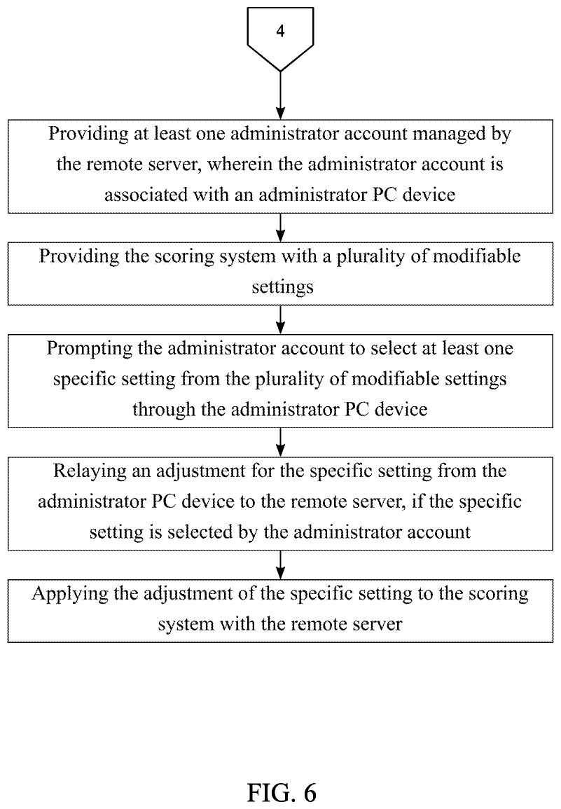

Referring to FIG. 4 to FIG. 6, the preferred embodiment uses a scoring system to calculate the social-service score for the arbitrary account. Preferably, the scoring system is hosted on the remote server. Further, the social-service score of the arbitrary account is recalculated in accordance to the scoring system during step G. In one embodiment, the scoring system may come with preprogrammed settings that cannot be changed by the administrator account. As such, the scoring system is configured with a plurality of preset settings. In this embodiment, the scoring system is hardcoded into the remote server and thus may not be modified by any one. In an alternate embodiment, the administrator account can modify the scoring system. As such, the scoring system is provided with a plurality of modifiable settings. The plurality of modifiable settings may affect how the different characteristics of the service activity is weighted. For instance, the duration of the service activity may be given a higher weight than the type of service activity.

Further, the administrator PC device prompts the administrator account to select at least one specific setting from the plurality of modifiable settings. This allows the administrator account to change the plurality of modifiable settings remotely from anywhere in the world. The plurality of modifiable settings may be changed directly from the administrator PC device. Changing the plurality of modifiable settings effects the way that the social-service score of each user account is generated, thus this responsibility is given to the administrator account. If the specific setting is selected by the administrator account, an adjustment for the specific setting is relayed from the administrator PC device to the remote server. The adjustment may relate to changing how different types of service activities are weighted in the calculation of the social-service score. Finally, the remote server applies the adjustment of the specific setting to the scoring system. In the preferred implementation, the remote server simultaneously changes the social-service score of the plurality of user accounts according to the adjustment made by the administrator account.

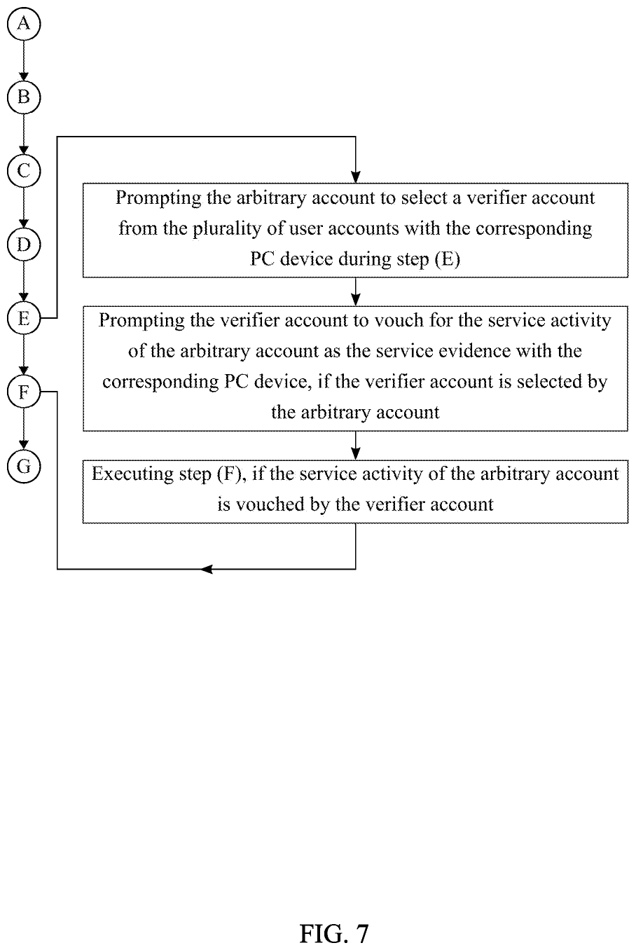

Referring to FIG. 7, in one embodiment, the remote server may accordingly update the social-service score of the plurality of user accounts. For the service activity submitted with a reference as the service evidence, the administrator contacts the person listed on the submission form. In order to verify the service activity, the person being referred to in the submission form will need to be a verified member with a user account. As such, with the corresponding PC device prompts the arbitrary account to select the verifier account from the plurality of user accounts during step E. The verifier account is preferably a user account which has be referred to by another user account. Alternately, the verifier account may be a specialized account devoted to authenticating service evidence provided by another user account. The verifier device like the PC device can be, but is not limited to, smartphones, laptops, desktops, personal digital assistants (PDAs), smartwatches, and the like. Subsequently, the corresponding PC device prompts the verifier account to vouch for the service activity of the arbitrary account as the service evidence, if the verifier account is selected by the arbitrary account. Accordingly, step F is executed, if the service activity of the arbitrary account is vouched by the verifier account. Once the service activity is authenticated by the verifier account, the administrator, through the administrator account, may review the service activity before being used to calculate the social-service score. Preferably, the user account can interact with other user accounts via instant messages, posting status updates, and the like, as well as sending and receiving friend requests. Further, the social-score for an arbitrary user account is visible to all available user accounts.

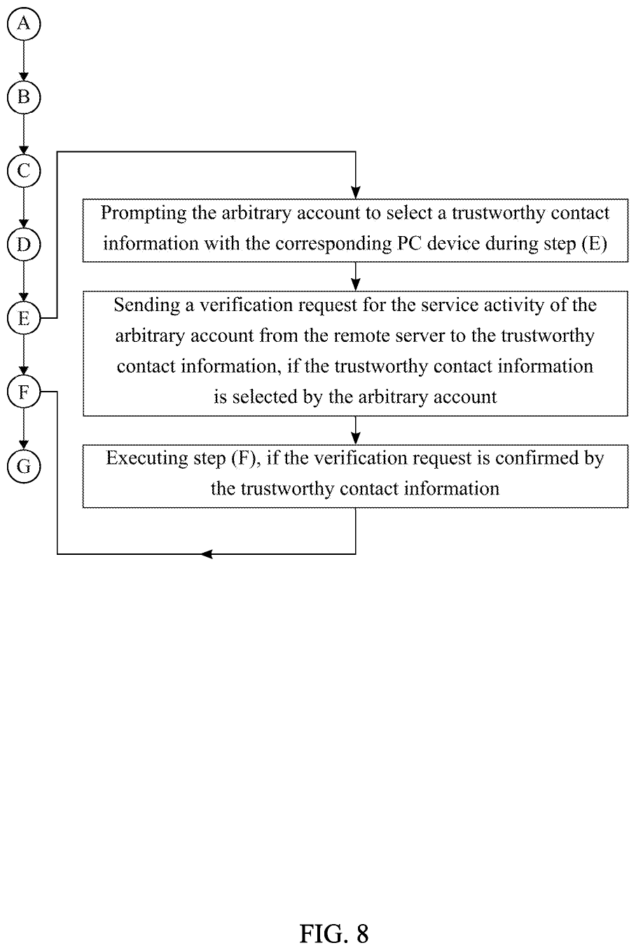

Referring to FIG. 8, alternately, the user account may provide contact information of a person outside of the social network. Accordingly, the corresponding PC device prompts the arbitrary account to select a trustworthy contact information during step E. Preferably, the user account provides the contact information of a person(s) who witnessed the service activity being performed. The contact information may be a name, phone number, address, and/or email address of the person identified as the reference. Further, the user account may provide a plurality of references, each with the corresponding contact information. As such, the remote server sends a verification request for the service activity of the arbitrary account to the trustworthy contact information, if the trustworthy contact information is selected by the arbitrary account. Subsequently, step F is executed, if the verification request is confirmed by the trustworthy contact information.

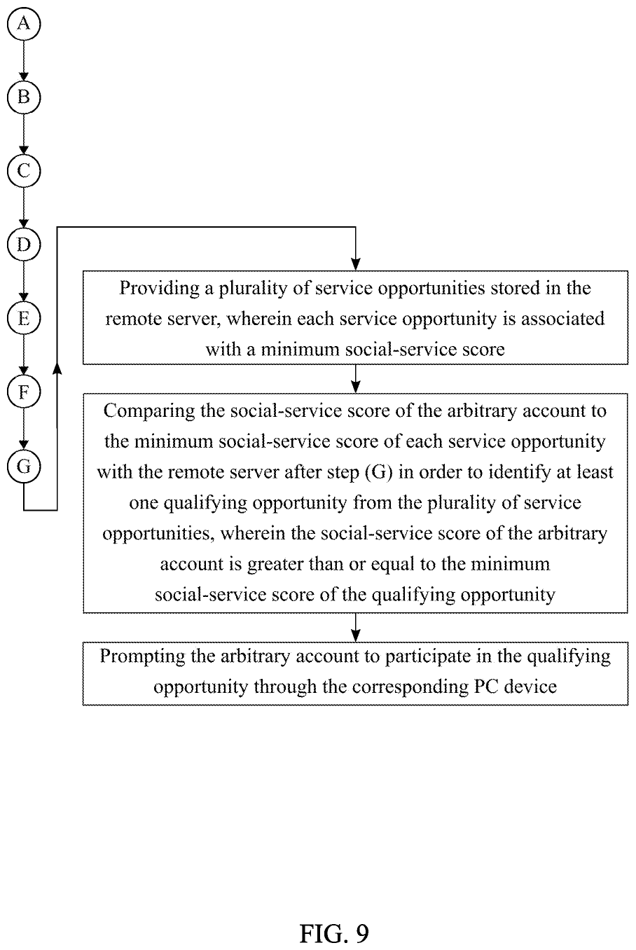

Referring to FIG. 9, the preferred embodiment of the present invention provides several incentives for the user to do and submit service activities. For instance, the social-service score can be used to market the user's upstanding character for job applications, resumes, loans, school applications, clubs, groups and business discounts. As such, a plurality of service opportunities stored in the remote server is provided, wherein each service opportunity is associated with a minimum social-service score. The plurality of service opportunities is submitted by various non-profit organizations to be promoted to plurality of user accounts. In the preferred embodiment, non-profit organization may need to open a specialized account devoted to promoting and dispensing the plurality of service opportunities. Alternately, the plurality of service opportunities may be submitted without a specialized account. The plurality of service opportunities allows users to boost the social-service score and participate the service activities match their interests and expertise. As a way to select promising users, each service opportunity has a minimum social-service score. The user is only presented a service opportunity with a minimum social-service score that matches or is lower than the social-service score of the user account. Subsequently, the remote server compares the social-service score of the arbitrary account to the minimum social-service score of each service opportunity after step (G) in order to identify at least one qualifying opportunity from the plurality of service opportunities, wherein the social-service score of the arbitrary account is greater than or equal to the minimum social-service score of the qualifying opportunity.

In the preferred embodiment, the qualifying service opportunity is chosen based solely on the minimum social-service score. However, in alternate embodiments, the remote server may take additional factors into account when selecting the qualifying opportunity including, but not limited to, the interests, location, age, sex, and availability of the user. This allows the user to check the PC device and quickly accept or defer the matching service opportunity. As such, the corresponding PC device prompts the arbitrary account to participate in the qualifying opportunity, to which the arbitrary account can either accept or decline. More specifically, the PC device may alert the user via visual and/or auditory notifications to accept or defer the qualifying opportunity.

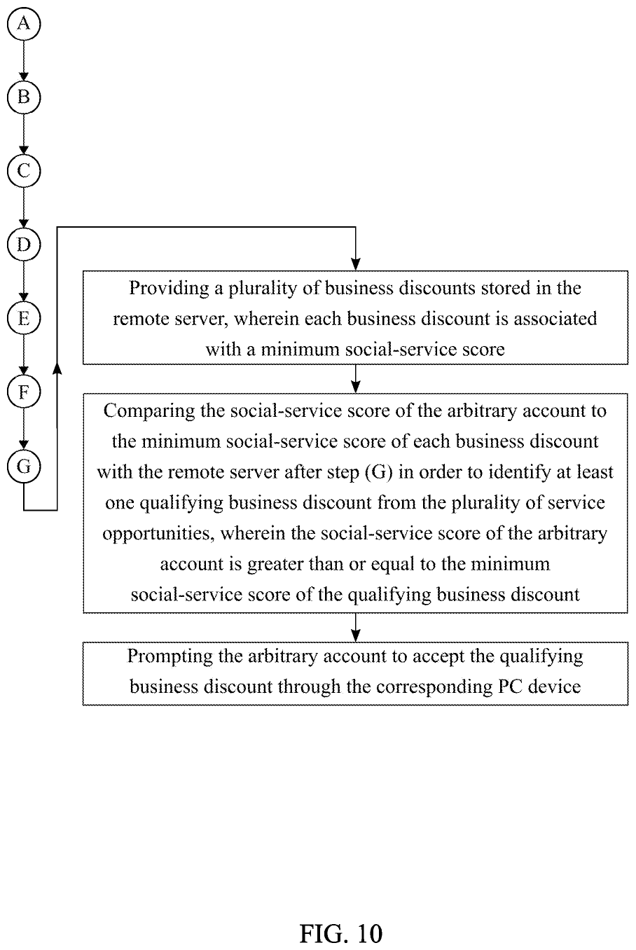

Referring to FIG. 10, in addition to providing users with the plurality of service opportunities, the present invention also provides incentives to encourage and reward users. As such, the present invention may be used as a marketing tool for businesses who purchase an annual membership that allows businesses to market their products to users with high social-service scores. Accordingly, a plurality of business discounts stored in the remote server is provided, wherein each business discount includes a minimum social-service score. Like the plurality of service opportunities, for the user account to be eligible for the plurality of business discounts, the social-service score on the user account must meet or exceed the minimum social-service score of a business discount. Accordingly, the remote server compares the social-service score of the arbitrary account to the minimum social-service score of each business discount after step G in order to identify at least one qualifying business discount from the plurality of business discounts, wherein the social-service score of the arbitrary account is greater than or equal to the minimum social-service score of the qualifying business discount. Alternately, the remote server may take additional factors into account when selecting the qualifying business discount from the plurality of service opportunities including, but not limited to, the age, sex, location, and income of the user. Further, the user may be able to select preferences for items on the user account and enter buying habits to further refine the preferences.

Accordingly, the corresponding PC device prompts the arbitrary account to accept the qualifying business discount, to which the arbitrary account can either accept or decline. This allows the user to accept or defer the qualifying business discount through the PC device without signing into the user account. More specifically, the matching service opportunity may pop up as an image showing the vital details of the qualifying business discount. In one possible embodiment, the qualifying business discount may be embodied on a pop-up notification that shows up on the screen of the PC device. The user may simple click on the image to accept or defer the matching service opportunity, without signing into the user account.

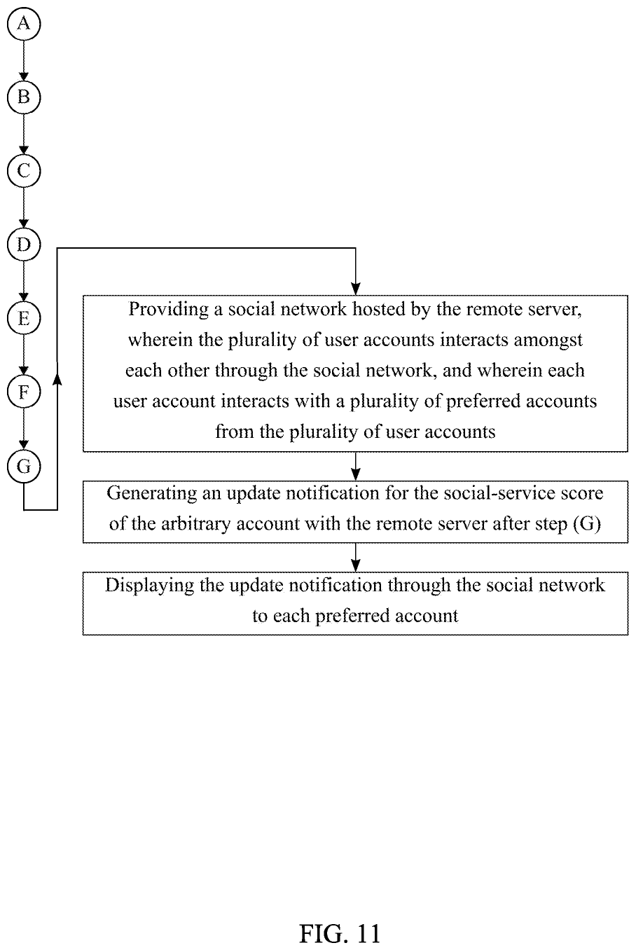

Referring to FIG. 11, in the preferred embodiment, a social network allows users to exchange shareable content with each other. In particular, each user account must send a friend request to the preferred account and the preferred account must accept the friend request exchange of shareable content. Accordingly, the social network is hosted by the remote server, wherein the plurality of user accounts interacts amongst each other through the social network, and wherein each user account interacts with a plurality of preferred accounts from the plurality of user accounts. Shareable content includes, but is not limited to, videos, images, update notifications, private messages, and the like. As such, the remote server generates an update notification for the social-service score of the arbitrary account after step G. The update notification alerts the preferred account when social-service score of the arbitrary account is updated. Accordingly, the preferred account may interact with the arbitrary account according to the update notification. For instance, the preferred account may send comment, like, and/or share the update notification with other preferred accounts. As such, the social network displays the update notification to each preferred account. Preferably, the update notification is displayed on the activity feed of the preferred account along with photos, message boards, and general activities of the plurality of preferred accounts. This allows the plurality of preferred accounts to like, share, or comment on the update notification and have the comments displayed on their own social network.

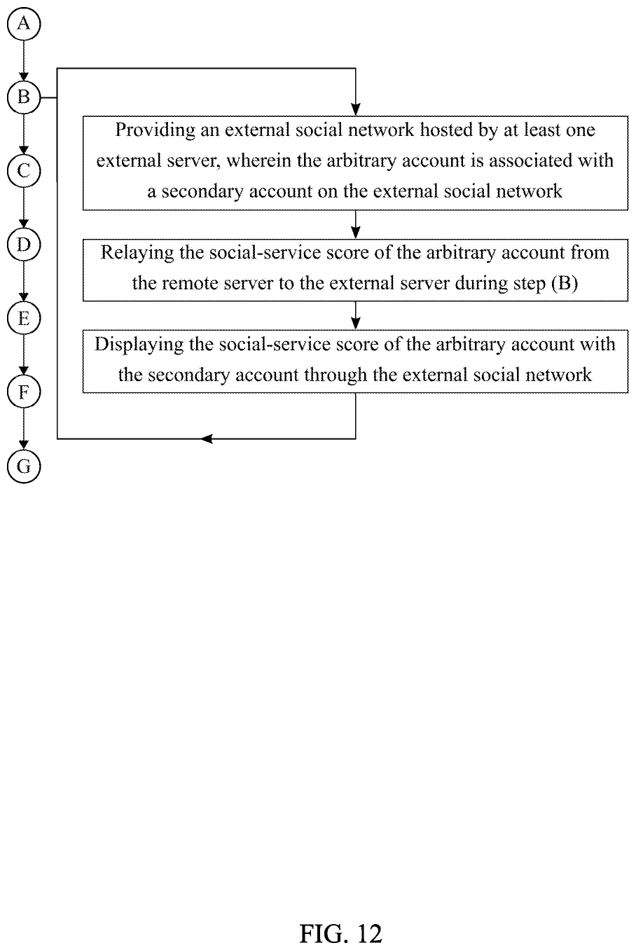

Referring to FIG. 12, in another embodiment, the social-service score may be shared on a social profile hosted on an external social network. As such, at least one external server hosts the external social network, wherein the arbitrary account is associated with a secondary account on the external social network. In one embodiment, the secondary account on the external social network may be linked to the arbitrary account through the internet. This allows the user to share his or her social-service score on job-searching websites or professional networking websites that allow job seekers to promote their CVs and personal experience.

The social-service score of the arbitrary account is relayed from the remote server to the external server during step B. Finally, the external social network displays the social-service score of the arbitrary account with the secondary account. Preferably, the social-service score can be used to market the user to prospective employers who are on the external social network. Alternately, the social-service score may also be shared on dating websites impress to romantic interests.

Although the invention has been explained in relation to its preferred embodiment, it is to be understood that many other possible modifications and variations can be made without departing from the spirit and scope of the invention as hereinafter claimed.

What is claimed is:

1. A method of implementing a social network for character testing and rewarding social service comprises:
(A) providing a plurality of user accounts managed by at least one remote server, wherein the user account is associated with a corresponding personal computing (PC) device;
(B) managing a social-service score for each user account with the remote server;
(C) prompting each user account to enter a service activity through the corresponding PC device;
(D) prompting an arbitrary account to enter at least one service evidence for the service activity through the corresponding PC device, if the service activity is entered in step (C) by the arbitrary account, wherein the arbitrary account is any account from the plurality of user accounts;
(E) executing an authentication process for the service activity with the remote server in order to verify the service activity with the service evidence;
(F) designating the service activity as at least one verified service activity with the remote server, if the service activity is verified by the service evidence during the authentication process; and
(G) appending the verified service activity into the social-service score of the arbitrary account with the remote server.

2. The method of implementing a social network for character testing and rewarding social service, the method as claimed in claim 1 comprises:
providing at least one administrator account managed by the remote server, wherein the administrator account is associated with an administrator PC device;
providing a user-inputted evidence as the service evidence;
relaying the user-inputted evidence from the remote server to the administrator PC device during step (E);
displaying the user-inputted evidence with the administrator PC device;
prompting the administrator account to approve or reject the user-inputted evidence through the administrator PC device; and
executing step (F), if the user-inputted evidence is approved by the administrator account.

3. The method of implementing a social network for character testing and rewarding social service, the method as claimed in claim 1 comprises:
providing a scoring system hosted on the remote server; and
recalculating the social-service score of the arbitrary account in accordance to the scoring system during step (G).

4. The method of implementing a social network for character testing and rewarding social service, the method as claimed in claim 3, wherein the scoring system is configured with a plurality of preset settings.

5. The method of implementing a social network for character testing and rewarding social service, the method as claimed in claim 3 comprises:
providing at least one administrator account managed by the remote server, wherein the administrator account is associated with an administrator PC device;
providing the scoring system with a plurality of modifiable settings;
prompting the administrator account to select at least one specific setting from the plurality of modifiable settings through the administrator PC device;
relaying an adjustment for the specific setting from the administrator PC device to the remote server, if the specific setting is selected by the administrator account; and
applying the adjustment of the specific setting to the scoring system with the remote server.

6. The method of implementing a social network for character testing and rewarding social service, the method as claimed in claim 1 comprises:
prompting the arbitrary account to select a verifier account from the plurality of user accounts with the corresponding PC device during step (E);
prompting the verifier account to vouch for the service activity of the arbitrary account as the service evidence with the corresponding PC device, if the verifier account is selected by the arbitrary account; and
executing step (F), if the service activity of the arbitrary account is vouched by the verifier account.

7. The method of implementing a social network for character testing and rewarding social service, the method as claimed in claim 1 comprises:
prompting the arbitrary account to select a trustworthy contact information with the corresponding PC device during step (E);
sending a verification request for the service activity of the arbitrary account from the remote server to the trustworthy contact information, if the trustworthy contact information is selected by the arbitrary account; and
executing step (F), if the verification request is confirmed by the trustworthy contact information.

8. The method of implementing a social network for character testing and rewarding social service, the method as claimed in claim 1 comprises:
providing a plurality of service opportunities stored in the remote server, wherein each service opportunity is associated with a minimum social-service score;
comparing the social-service score of the arbitrary account to the minimum social-service score of each service opportunity with the remote server after step (G) in order to identify at least one qualifying opportunity from the plurality of service opportunities, wherein the social-service score of the arbitrary account is greater than or equal to the minimum social-service score of the qualifying opportunity; and
prompting the arbitrary account to participate in the qualifying opportunity through the corresponding PC device.

9. The method of implementing a social network for character testing and rewarding social service, the method as claimed in claim 1 comprises:
providing a plurality of business discounts stored in the remote server, wherein each business discount includes a minimum social-service score;
comparing the social-service score of the arbitrary account to the minimum social-service score of each business discount with the remote server after step (G) in order to identify at least one qualifying business discount from the plurality of business discounts, wherein the social-service score of the arbitrary account is greater than or equal to the minimum social-service score of the qualifying business discount; and
prompting the arbitrary account to accept the qualifying business discount through the corresponding PC device.

10. The method of implementing a social network for character testing and rewarding social service, the method as claimed in claim 1 comprises:
providing a social network hosted by the remote server, wherein the plurality of user accounts interacts amongst each other through the social network, and wherein each user account interacts with a plurality of preferred accounts from the plurality of user accounts;
generating an update notification for the social-service score of the arbitrary account with the remote server after step (G); and
displaying the update notification through the social network to each preferred account.

11. The method of implementing a social network for character testing and rewarling social service, the method as claimed in claim 1 comprises:
providing an external social network hosted by at least one external server, wherein the arbitrary account is associated with a secondary account on the external social network;
relaying the social-service score of the arbitrary account from the remote server to the external server during step (B); and
displaying the social-service score of the arbitrary account with the secondary account through the external social network.
